(19) United States
(12) Patent Application Publication
(10) Pub. No.: US 2007/0080644 A1
(43) Pub. Date: Apr. 12, 2007

(54) Plasma display panel

(76) Inventors: Eui Jeong Hwang, Youngin-si (KR); Tae Weon Heo, Youngin-si (KR)

Correspondence Address: LEE & MORSE, P.C., 3141 FAIRVIEW PARK DRIVE, SUITE 500, FALLS CHURCH, VA, 22042, US

(21) Appl. No.: 11/412,107

(22) Filed: Apr. 27, 2006

(30) Foreign Application Priority Data
Apr. 27, 2005 (KR) 2005-0035293

(51) Int. Cl. H01J 17/02

(52) U.S. Cl. 313/610

(57) ABSTRACT

A plasma display panel includes two substrates spaced from each other by a predetermined interval so as to form a space therebetween, barrier ribs dividing the space between the two substrates, thereby defining discharge cells, a drive electrode installed for a plasma discharge in the discharge cells, discharge gas filled in the space and a fluorescent layer on at least one part of the substrates and the barrier ribs. The drive electrode includes an address electrode and a sustain electrode, the sustain electrode includes main electrodes aligned in rows and auxiliary electrodes connected to the main electrodes, and at least a part of the auxiliary electrodes extends obliquely to the main electrodes.

### BACKGROUND OF THE INVENTION

1. Field of the Invention

The present invention relates to a plasma display panel. More particularly, the present invention relates to the formation and arrangement of sustain electrodes of a plasma display panel.

2. Description of the Prior Art

As generally known in the art, a plasma display device refers to a flat panel display device using a plasma display panel (“PDP”; hereinafter, the PDP may also be referred to as a panel) which can be made by forming electrodes on two opposing substrates, respectively, overlapping the two substrates such that a predetermined space is formed therebetween, injecting discharge gas into the space, and sealing the space. After preparing the PDP, elements required for displaying an image, such as driving circuits connected to the electrodes of the plasma display panel, are installed on the PDP, thereby realizing a plasma display device.

A matrix of pixels is provided in the PDP in order to display the image on a screen. In the above PDP, each pixel can be driven by simply applying the voltage to each pixel electrode through a passive matrix scheme, i.e., without using an active device. PDPs can be classified as a DC type PDP and an AC type PDP according to the voltage signal used for driving each electrode. In addition, PDPs can be classified into an opposed type plasma display panel and a surface discharge type plasma display panel according to the relative positioning of the two electrodes to which the discharge voltage is applied.

An exemplary AC type PDP, shown in FIG. 8, includes a front substrate 10 and a rear substrate 11. Sustain electrodes 50 may be formed on the rear substrate 11. The sustain electrodes 50 may include a pair of electrodes 30, 40 (display electrodes and scanning electrodes) alternating with each other in the horizontal direction. A first dielectric film 15 may cover the sustain electrodes 50. Address electrodes 14 may be formed on the first dielectric film 15 and a second dielectric film 13 may be positioned thereon. The address electrodes 14 may cross the sustain electrodes 50 while being perpendicular thereto, i.e., intersect the sustain electrodes 50. A protective film 16, e.g., MgO, may be formed on the second dielectric film 13. The sustain electrodes 50 and the address electrodes 14 may be provided on inner portions of different substrates.

Barrier ribs 20 may be formed on the inner surface of the front substrate 10 facing the rear substrate 11. The barrier ribs 20 may be formed in various shapes and by various methods. The front substrate 10 may have a phosphor material 23, e.g., fluorescent layer, positioned for each cell on the inner surface thereof, i.e., on the surface having the barrier ribs 20 thereon, as well as on sidewalls of the barrier ribs 20. The phosphor material 23 may be provided by various conventional methods. The phosphor material 23 may also be on the rear substrate 11.

As noted above, in the AC type PDP, the electrodes are covered with dielectric layers 13, 15. Thus, the electrodes have an inherent capacitance due to the dielectric layers 13, 15, limiting the current applied to thereto. Thus, the electrodes can be protected from the ion bombardment during the discharge operation. As a result, the electrode life span may be lengthened.

The display electrodes are commonly connected to one lateral side of the panel. When viewed from the top of a cell forming the pixel, one vertical electrode (address electrode) and two horizontal electrodes (scanning and display electrodes) are alternately provided. In a top emission type plasma display device, the sustain electrode includes a transparent electrode that does not interfere with the light, and a bus electrode, as discussed in detail below. The bus electrode is typically opaque, has a higher conductivity and smaller surface area than the transparent electrode, and is connected to the transparent electrode in a row.

The alignment of the pixels in a matrix can be realized by the arrangement of barrier ribs and electrodes in a variety of manners. For example, the barrier ribs can be aligned in the form of a stripe matrix pattern in which the barrier ribs are aligned with the address electrodes vertically into columns, in the form of a grid matrix pattern in which the barrier ribs are aligned vertically and horizontally into columns and rows, thereby defining cells, and in the form of a delta-type matrix pattern in which three adjacent discharge cells aligned in a triangular pattern form one pixel.

FIG. 1 illustrates a plan view of an electrode structure for each pixel in a conventional stripe matrix type PDP. The electrode structure shown in FIG. 1 is arranged relative to barrier ribs 20, which are aligned with address electrodes (not shown). Sustain electrodes 50 include a pair of electrodes 30, 40 crossing the barrier ribs 20 and further defining a discharge cell. Each electrode in the pair may include a bus electrode 31, 41 and a transparent electrode 33, 43.

In the stripe type barrier rib structure shown in FIG. 1, adjacent cells of the panel are along one linear line in the longitudinal or transverse direction. Such a structure may simplify the process for forming the barrier ribs 20, but may complicate the alignment of sustain electrodes 50 for preventing cross talk between upper and lower cells. That is, an interval between adjacent bus electrodes 31 and 41 of the sustain electrode 50 provided between upper and lower discharge cells must be larger than a gap formed between transparent electrodes 33 and 43 aligned in opposition to each other within the discharge cells. Therefore, in order to maintain a predetermined interval between the bus electrodes 31 and 41, the discharge area must be reduced, degrading discharge efficiency and light emitting efficiency.

In order to address this, although not illustrated for this particular configuration, the barrier ribs may be provided in a grid matrix pattern such that the barrier ribs correspond to the sustain electrode as well as the address electrodes, while overlapping the barrier ribs provided in the row direction with the opaque bus electrodes of the sustain electrodes in order to prevent the aperture ratio from being reduced. An example of such a grid matrix may be seen in FIG. 3.

FIG. 2 illustrates a plan view of auxiliary bus electrodes provided in the discharge cells shown in FIG. 1.

In FIG. 2, auxiliary bus electrodes 35 and 45 are provided to improve bright room contrast of the PDP, to promote the plasma discharge in the discharge cells and to easily spread plasma over the whole area of the cells. In general, the auxiliary bus electrodes 35 and 45 are formed together with the bus electrodes 31 and 41. The auxiliary bus electrodes 35, 45 extend over the transparent electrodes 33, 43.

However, such formation may reduce the width of the auxiliary bus electrodes as the width of the main bus electrodes is decreased in order to prevent the brightness of the plasma display panel from being reduced. In addition, if the process condition is deteriorated during a pattern forming process, a notch or other discontinuities may be created in the pattern, thereby causing the auxiliary bus electrodes 35 and 45 to be disconnected. If the auxiliary bus electrodes 35 and 45 are disconnected, the electrode pattern aligned next to the disconnected portion in the discharge cell may not serve as the auxiliary bus electrode, so the brightness of the PDP may be degraded. That is, since end tips of the auxiliary bus electrodes 35 and 45 promote the plasma discharge in the discharge cell, if the auxiliary bus electrodes 35 and 45 are disconnected, the plasma discharge is not reliably generated in the PDP panel and plasma may not be easily ignited, thereby degrading the image quality.

FIG. 3 illustrates a plan view of another sustain electrode arrangement including bus electrodes fabricated in the form of a ladder. As shown in FIG. 3, the barrier ribs 20 include longitudinal ribs 21 and transverse ribs 23, forming a grid matrix pattern.

As shown in FIG. 3, when the sustain electrodes 30 are in a ladder configuration, the sustain electrodes 30 include two main bus electrodes 32 and 32′ traverse upper and lower discharge cells, respectively, and are connected to each other by transparent electrodes 34 and auxiliary bus electrodes 36. The transparent electrodes 34 also extend into the discharge cell. Similarly, the sustain electrodes 40 are in a ladder configuration, and include two main bus electrodes, with only one main bus electrode 42 shown, and auxiliary bus electrodes 46, as well as the transparent electrodes 44, extending between the two main bus electrodes. The voltage of the bus electrodes are bi-directionally applied to the respective two main bus electrodes even if the auxiliary bus electrodes 36 and 46 are disconnected, so that reliability of the auxiliary bus electrodes 36 and 46 can be improved. Accordingly, bright room contrast can be improved due to the auxiliary bus electrodes, and plasma can be reliably spread.

As shown in FIGS. 2 and 3, when auxiliary bus electrodes are provided, the plasma discharge generated from the center of each discharge cell may spread in upper and lower directions along the transparent electrode pattern and the auxiliary bus electrodes. However, such a plasma discharge tends to be concentrated on the auxiliary bus electrodes because the auxiliary bus electrodes have relatively low electric resistance. For this reason, the conventional auxiliary bus electrodes still do not sufficiently utilize the whole cell area as the plasma discharge area.

### SUMMARY OF THE INVENTION

The present invention is therefore directed to an auxiliary electrode arrangement for sustain electrodes and a PDP having the same, which substantially overcome one or more of the problems due to the limitations and disadvantages of the related art.

It is therefore a feature of an embodiment of the present invention to provide auxiliary electrodes that spread the plasma discharge within a narrow area of the auxiliary electrode, thereby improving the discharge efficiency of discharge cells.

It is another feature of an embodiment of the present invention to provide a PDP having an improved the bright room contrast while uniformly spreading plasma over the whole area of the discharge cell area.

It is further another feature of an embodiment of the present invention to provide a PDP having auxiliary electrodes that stably spread the plasma even if a part of the auxiliary electrodes provided in the sustain electrode of the PDP is disconnected.

At least one of the above and other features and advantages of the present invention may be realized by providing a plasma display panel, including two substrates spaced from each other by a predetermined interval so as to form a space therebetween, barrier ribs dividing the space between the two substrates, thereby defining discharge cells, a drive electrode installed for a plasma discharge in the discharge cells, discharge gas filled in the space, and a phosphor within the discharge cells. The drive electrode includes an address electrode and a sustain electrode, the sustain electrode includes main electrodes aligned in rows and auxiliary electrodes connected to the main electrodes, and at least a part of the auxiliary electrodes extends obliquely to the main electrodes.

The main electrodes may be aligned in the discharge cells such that the main electrodes traverse the discharge cells. At least a part of the auxiliary electrodes may be in the discharge cells. The barrier ribs may form a rectangular discharge cell. An auxiliary electrode may include two branches extending towards two adjacent edges of the rectangular discharge cell from a center portion of the main electrode in the discharge cell. The at least two branches extending toward the edge of the discharge cell may contact each other at a predetermined edge of the discharge cell in which at least two discharge cells make contact with the predetermined edge. The auxiliary electrode may further include a third branch extending toward a center of the discharge cell from the main electrode in a direction opposite to an extending direction of two branches about the main electrode. The auxiliary electrode may include an I-shaped branch part extending toward the barrier rib, which is adjacent to the main electrode in a column direction, from a center of the main electrode aligned in the discharge cell, and two branch parts extending toward two edges of the rectangular discharge cell which are adjacent to an end portion of the barrier rib to which the I-shaped branch part is directed.

The sustain electrode may include two transparent electrodes connected to the main electrodes aligned in the discharge cells while forming a predetermined gap therebetween. The auxiliary electrode may be in a predetermined region where the transparent electrodes are formed.

At least one of the above and other features and advantages of the present invention may be realized by providing a plasma display panel including two substrates spaced from each other by a predetermined interval so as to form a space therebetween, barrier ribs dividing the space into a grid type matrix between two substrates, thereby defining a rectangular discharge cell matrix, a drive electrode installed for a plasma discharge in discharge cells, discharge gas filled in the space, and a phosphor within the discharge cell. The drive electrode includes an address electrode and a sustain electrode, and the sustain electrode includes two main electrodes, which transversely pass through a lower portion of an upper discharge cell row and an upper portion of a lower discharge cell row, respectively, and branch parts extending obliquely between the two main electrodes and forming a part of a line connecting the two main electrodes with each other.

The oblique branch parts may be connected with each other at a predetermined edge of the discharge cell in which at least two discharge cells make contact with the predetermined edge.

The sustain electrode may include two transparent electrodes connected to the main electrodes aligned in the discharge cells while forming a predetermined gap therebetween.

The auxiliary electrode may have an oblique branch extending diagonally from a center portion of the main electrode in a predetermined discharge cell of the upper discharge cell row toward the main electrode aligned in the discharge cell of the lower discharge cell row and passing through an adjacent edge of the predetermined discharge cell. The two oblique branch parts may intersect in at least one edge of the rectangular discharge cell. The auxiliary electrode may include a third branch part extending toward a center of the discharge cell from the main electrode in a direction opposite to an extending direction of the oblique branch parts about the main electrode.

The auxiliary electrode may include an I-shaped branch part extending toward the barrier rib, which is adjacent to the main electrode in a column direction, from a center of the main electrode aligned in the discharge cell and oblique branch parts extending toward two edges of the rectangular discharge cell which are adjacent to an end portion of the barrier rib to which the I-shaped branch part is directed.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a plan view of an electrode structure for each pixel in a conventional matrix type plasma display panel;

FIG. 2 illustrates a plan view of auxiliary bus electrodes provided in discharge cells of a conventional plasma display panel;

FIG. 3 illustrates a plan view of bus electrodes in ladder form in a conventional plasma display panel;

FIG. 4 illustrates a plan view of the arrangement of main electrodes forming sustain electrodes passing through upper and lower pixels, transparent electrodes, auxiliary electrodes and barrier ribs of a plasma display panel according to an embodiment of the present invention;

FIG. 5 illustrates a plan view of the arrangement of main electrodes forming sustain electrodes passing through upper and lower pixels, transparent electrodes, auxiliary electrodes and barrier ribs of a plasma display panel according to another embodiment of the present invention;

FIGS. 6 and 7 illustrate plan views of variations on the arrangement shown in FIG. 4; and

FIG. 8 illustrates an exploded perspective schematic view of a pixel unit of a plasma display panel.

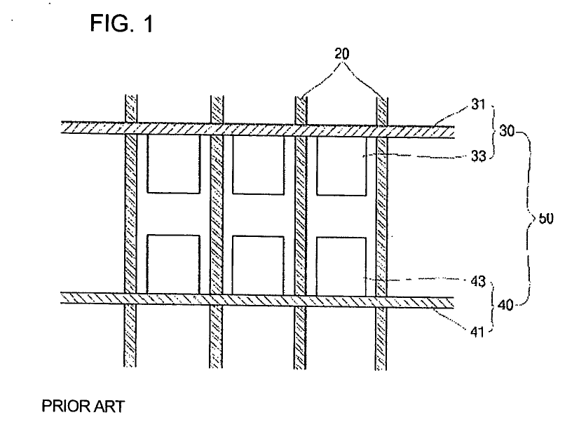

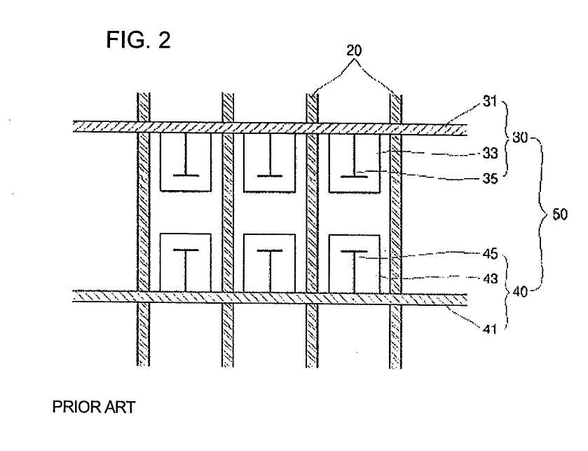

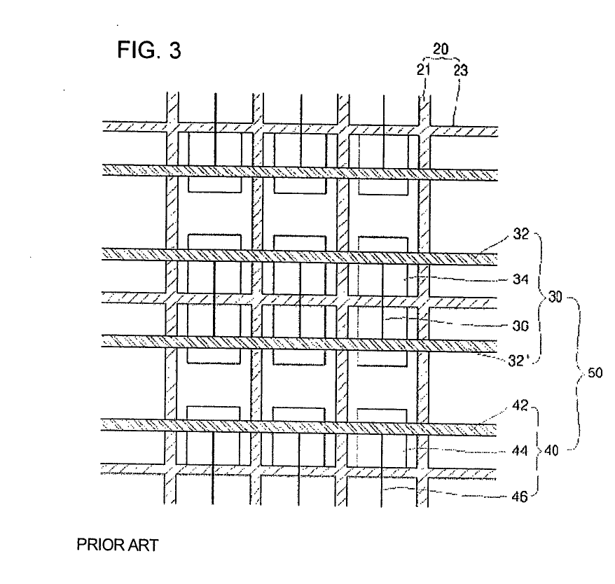

### DETAILED DESCRIPTION OF THE INVENTION

Korean Patent Application No. 2005-0035293, filed on Apr. 27, 2005, in the Korean Intellectual Property Office, and entitled, “Plasma Display Panel,” is incorporated herein by reference in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “betweenn” two layers, it can be the only layer between the two layers, or one or more intervening layers may also be present. In the following description and drawings, like reference numerals are used to designate the same or similar components, and so repetition of the description on the same or similar components will be omitted.

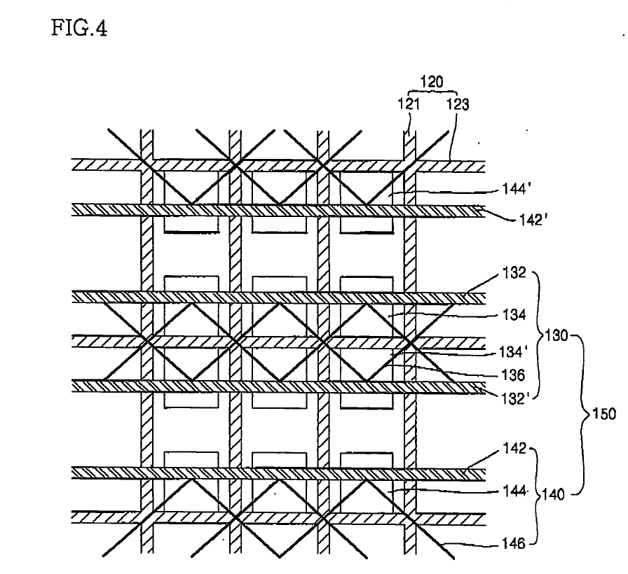

FIG. 4 illustrates a plan view of an arrangement of main electrodes forming sustain electrodes passing through upper and lower pixels, transparent electrodes, auxiliary electrodes and barrier ribs of a PDP according to an embodiment of the present invention. As shown in FIG. 4, barrier ribs 120 may include longitudinal ribs 121 and transverse ribs 123 defining discharge cells. Sustain electrodes 150 include a sustain electrode pair 130,140. Each electrode of the pair includes two main electrodes 132, 132′ and 142,142′, respectively, transparent electrodes 134,134′, 144,144′ extending therefrom, and auxiliary electrodes 136, 146 extending between the two main electrodes.

The transparent electrodes 134′ and 144 may be formed in upper and lower portions of each discharge cell forming the pixel, respectively, and a predetermined gap may be formed between two transparent electrodes 134′ and 144 within the discharge cell. Each cell may include two main electrodes 132′ and 142, which transversely extend and serve as bus electrodes. The upper main electrode 132′ traverses upper transparent electrodes 134′ and the lower main electrode 142 traverses lower transparent electrodes 144.

The main electrode 132 traversing a lower portion of an upper pixel receives a signal identical to a signal applied to the upper main electrode 132′ traversing an upper portion of a lower pixel. The plurality of auxiliary electrodes 136 may be provided between the main electrode 132 and the upper main electrode 132′ in the form of oblique lines and serve as further bus electrodes. The auxiliary electrodes 136 may contact each other at a periphery of a quadrangle defined by barrier ribs 121 and 123 of the discharge cell so that the auxiliary electrodes 136 form an X-shaped pattern at the edge part of the quadrangle. Relative to each discharge cell, the auxiliary electrodes 136 may contact the main electrodes 132 and 132′ at the center of the discharge cell, thereby forming a V-shaped pattern.

Two main electrodes 132 and 132′ forming one sustain electrode and the auxiliary electrodes 136 connecting the main electrodes 132 and 132′ to each other may have substantially similar voltage because a voltage drop due to resistance in the electrodes is very small. In addition, since the auxiliary electrodes are connected to each other in the form of the X-shaped pattern, the auxiliary electrodes can induce the spread of plasma discharge even if parts of the auxiliary electrodes are disconnected, e.g., due to a narrow width thereof. In other words, as long as one of the auxiliary electrodes forming the X-shaped pattern operates normally, the plasma discharge can be stably spread even if three of the auxiliary electrodes forming the X-shaped pattern are disconnected. When viewed from a front of the panel, the auxiliary electrodes 136 substantially overlap the transparent electrodes 134 and 134′ and the barrier rib 120.

Auxiliary electrodes 146 provide an analogous structure between the lower main electrode 142 and its corresponding ladder main electrode (not shown).

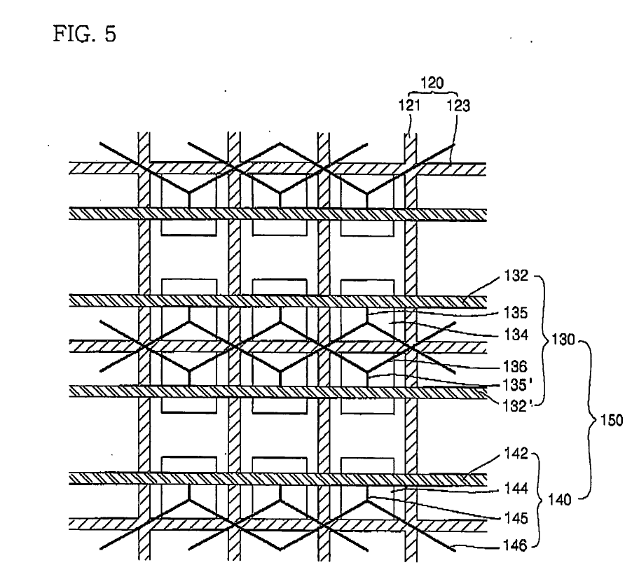

FIG. 5 illustrates a plan view of the arrangement of main electrodes forming sustain electrodes passing through upper and lower discharge cells, transparent electrodes, auxiliary electrodes and barrier ribs of a plasma display panel according to another embodiment of the present invention.

Referring to FIG. 5, similarly to FIG. 4, transparent electrodes 134′ and 144 are formed in upper and lower portions of each discharge cell forming the pixel, respectively, and a predetermined gap is formed between two transparent electrodes 134′ and 144. Each cell has two main electrodes 132′ and 142 extending transversely therein.

The main electrode 132 passing through a lower portion of an upper discharge cell receives a signal identical to a signal applied to the upper main electrode 132′ passing through an upper portion of a lower discharge cell. The plurality of auxiliary electrodes 136 may be provided between two main electrodes 132 and 132′ in the form of oblique lines. Again, the auxiliary electrodes 136 may contact each other at a periphery of the quadrangle defined by the barrier ribs 120 of the discharge cell so that the auxiliary electrodes 136 form an X-shaped pattern. However, different from FIG. 4, the auxiliary electrodes 136 may contact the main electrodes 132 and 132′ at the center of the discharge cell through I-shaped electrodes 135 and 135′. As a result, within each discharge cell, the auxiliary bus electrodes 136, along with the I-shaped electrodes 135,135′, in FIG. 5 form a Y-shaped pattern, instead of the V-shaped pattern shown in FIG. 4. Similarly, the auxiliary electrodes 146 along with an I-shaped electrode 145 together form a Y-shaped pattern.

In this case, since the auxiliary bus electrodes 136 having a mesh structure are provided between two main electrodes 132 and 132′ in order to connect the main electrodes 132 and 132′ to each other, the auxiliary bus electrodes 136 can reliably spread the plasma even if a portion of the mesh structure is disconnected. In addition, if the plasma discharge is expanded about the auxiliary bus electrodes having the mesh structure, the plasma discharge can be spread over a larger area as compared with the plasma discharge obtained with the conventional auxiliary bus electrodes having the I-shaped structure, so the discharge efficiency can be improved.

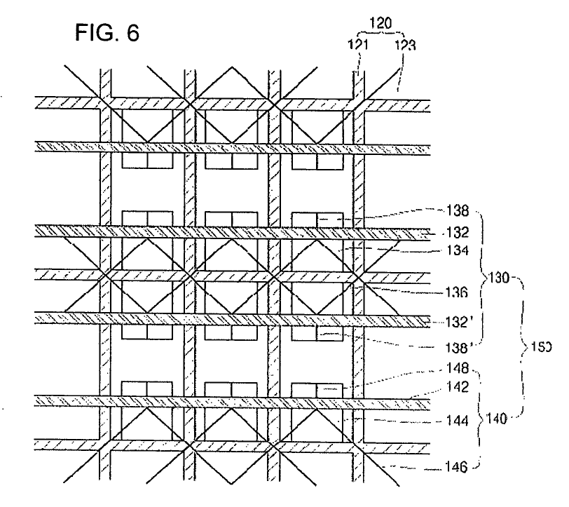

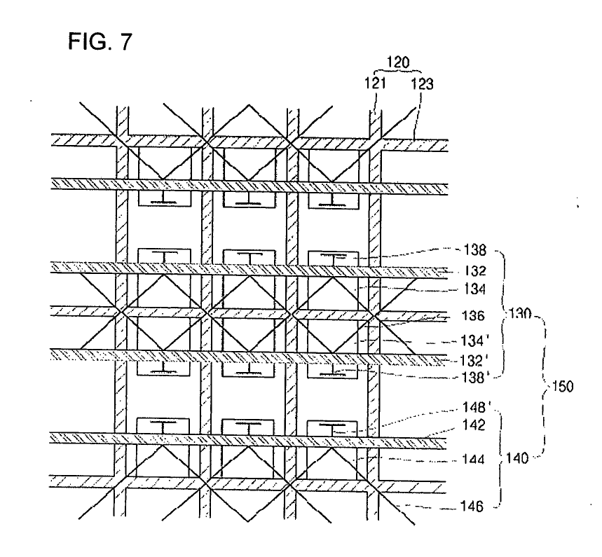

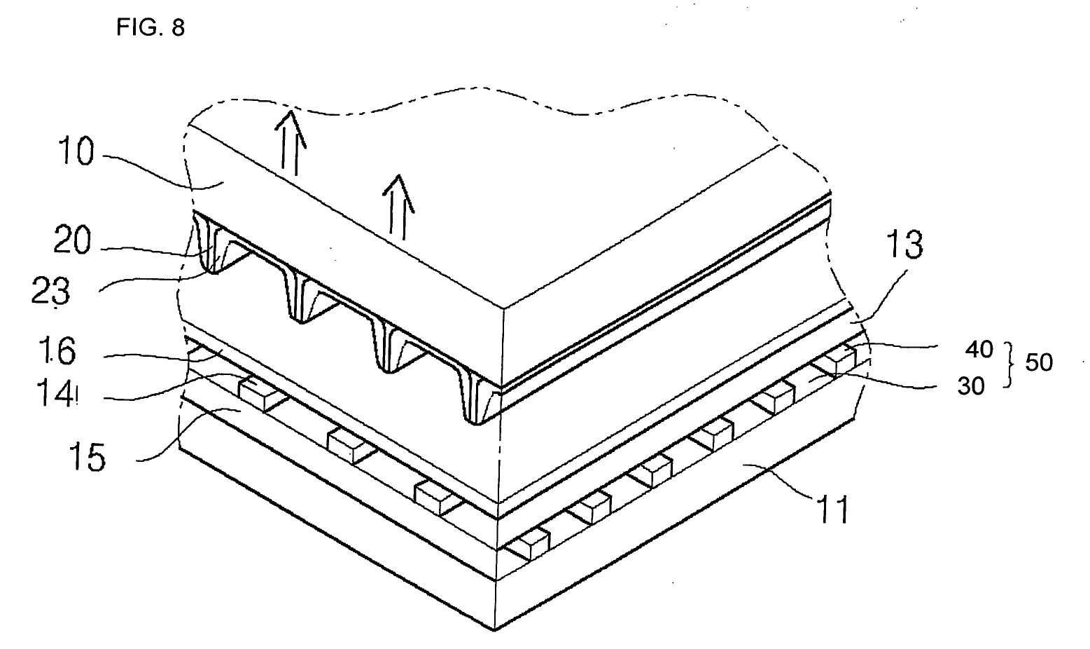

FIGS. 6 and 7 illustrate plan views of the arrangement of main electrodes forming sustain electrodes passing through upper and lower pixels, transparent electrodes, auxiliary bus electrodes and barrier ribs of a plasma display panel according to additional embodiments of the present invention.

The arrangement shown in FIGS. 6 and 7 basically has main electrodes 132,132′ and 142, transparent electrodes 134, 134′ and 144, auxiliary electrodes 136 and 146, and barrier ribs 121 and 123, which are identical to those of the PDP shown in FIG. 4. A plurality of auxiliary electrodes 136 are provided between two main electrodes 132 and 132′ in the form of oblique lines. The auxiliary electrodes 136 may contact each other at a periphery of the quadrangle defined by the barrier rib of the discharge cell so that the auxiliary electrodes 136 form an X-shaped pattern.

However, differently from FIG. 4, the auxiliary electrode may include auxiliary electrode parts 138, 138′ and 148 extending toward the gaps of the discharge cells at predetermined portions of main electrodes 132,132′ and 142 corresponding to contact portions between center portions of the discharge cells and the V-shaped auxiliary electrodes. The auxiliary electrode parts 138,138′ and 148 extending toward the gaps of the discharge cells may have I-shaped structures, as shown in FIG. 6, or T-shaped structures, as shown in FIG. 7. In this case, the plasma discharge may be promoted and easily spread due to the I-shaped or T-shaped auxiliary electrode parts 138,138′ and 148, and the bright room contrast can be improved.

If the upper and lower discharge cell rows share the sustain electrode according to the present invention, the sustain electrode may be driven using an ALIS (alternative lightening of surface) scheme.

Although exemplary embodiments of the present invention have been described for illustrative purposes, those skilled in the art will appreciate that various modifications, additions and substitutions are possible, without departing from the scope and spirit of the invention as disclosed in the accompanying claims. According to the present invention, the auxiliary electrode may extend towards a periphery of a cell from a center of the main electrode, so that the barrier rib can collect charged particles during the discharge operation, thereby preventing the plasma discharge from being attenuated while effectively enlarging the plasma discharge area.

According to the present invention, the bright room contrast may be improved without causing additional costs by simply changing the structure of the auxiliary electrode to more evenly spread the plasma discharge over the whole discharge cell area, e.g., by increasing a surface area covered by, but not a width of, the auxiliary electrodes.

In addition, according to the present invention, the plasma discharge can be reliably spread even if a part of the auxiliary electrodes is disconnected, due to the redundancy of the auxiliary electrode structure, i.e., having an auxiliary electrode connecting main bus electrodes in adjacent discharge cells.

Therefore, the present invention can stably enhance the plasma discharge efficiency in the discharge cell.

Exemplary embodiments of the present invention have been disclosed herein, and although specific terms are employed, they are used and are to be interpreted in a generic and descriptive sense only and not for purpose of limitation. For example, auxiliary electrode parts extending towards the gaps as illustrated in FIGS. 6 and 7 may also be used with the embodiment shown in FIG. 5. Further, while it has been assumed throughout that the main bus electrode, the auxiliary electrodes and the auxiliary electrode parts are made of the same material, these portions may be made of different, highly conductive materials. Accordingly, it will be understood by those of ordinary skill in the art that various changes in form and details may be made without departing from the spirit and scope of the present invention as set forth in the following claims.

What is claimed is:

1. A plasma display panel, comprising:
two substrates spaced from each other by a predetermined interval so as to form a space therebetween;
barrier ribs dividing the space between the two substrates, thereby defining discharge cells;
a drive electrode installed for a plasma discharge in the discharge cells;
discharge gas filled in the space; and
a phosphor within the discharge cells, wherein the drive electrode includes an address electrode and a sustain electrode, the sustain electrode includes main electrodes aligned in rows and auxiliary electrodes connected to the main electrodes, and at least a part of the auxiliary electrodes extends obliquely to the main electrodes.

2. The plasma display panel as claimed in claim 1, wherein the main electrodes are aligned in the discharge cells such that the main electrodes traverse the discharge cells.

3. The plasma display panel as claimed in claim 2, wherein at least a part of the auxiliary electrodes is in the discharge cells.

4. The plasma display panel as claimed in claim 2, wherein the barrier ribs form a rectangular discharge cell.

5. The plasma display panel as claimed in claim 4, wherein an auxiliary electrode includes two branches extending towards two adjacent edges of the rectangular discharge cell from a center portion of the main electrode in the discharge cell.

6. The plasma display panel as claimed in claim 5, wherein at least two branches extending toward the edge of the discharge cell contact each other at a predetermined edge of the discharge cell in which at least two discharge cells make contact with the predetermined edge.

7. The plasma display panel as claimed in claim 5, wherein the auxiliary electrode further includes a third branch extending toward a center of the discharge cell from the main electrode in a direction opposite to an extending direction of two branches about the main electrode.

8. The plasma display panel as claimed in claim 4, wherein the auxiliary electrode includes an I-shaped branch part extending toward the barrier rib, which is adjacent to the main electrode in a column direction, from a center of the main electrode aligned in the discharge cell, and two branch parts extending toward two edges of the rectangular discharge cell which are adjacent to an end portion of the barrier rib to which the I-shaped branch part is directed.

9. The plasma display panel as claimed in claim 1, wherein the sustain electrode includes two transparent electrodes connected to the main electrodes aligned in the discharge cells while forming a predetermined gap therebetween.

10. The plasma display panel as claimed in claim 9, wherein the auxiliary electrode is in a predetermined region where the transparent electrodes are formed.

11. A plasma display panel, comprising:
two substrates spaced from each other by a predetermined interval so as to form a space therebetween;
barrier ribs dividing the space into a grid type matrix between two substrates, thereby defining a rectangular discharge cell matrix;
a drive electrode installed for a plasma discharge in discharge cells;
discharge gas filled in the space; and
a phosphor within the discharge cells, wherein the drive electrode includes an address electrode and a sustain electrode, and the sustain electrode includes two main electrodes, which transversely pass through a lower portion of an upper discharge cell row and an upper portion of a lower discharge cell row, respectively, and branch parts extending obliquely between the two main electrodes and forming a part of a line connecting the two main electrodes with each other.

12. The plasma display panel as claimed in claim 11, wherein the oblique branch parts are connected with each other at a predetermined edge of the discharge cell in which at least two discharge cells make contact with the predetermined edge.

13. The plasma display panel as claimed in claim 11, wherein the sustain electrode includes two transparent electrodes connected to the main electrodes aligned in the discharge cells while forming a predetermined gap therebetween.

14. The plasma display panel as claimed in claim 11, wherein the auxiliary electrode has an oblique branch extending diagonally from a center portion of the main electrode in a predetermined discharge cell of the upper discharge cell row toward the main electrode aligned in the discharge cell of the lower discharge cell row and passing through an adjacent edge of the predetermined discharge cell.

15. The plasma display panel as claimed in claim 14, wherein two oblique branch parts intersect in at least one edge of the rectangular discharge cell.

16. The plasma display panel as claimed in claim 15, wherein the auxiliary electrode further includes a third branch part extending toward a center of the discharge cell from the main electrode in a direction opposite to an extending direction of the oblique branch parts about the main electrode.

17. The plasma display panel as claimed in claim 11, wherein the auxiliary electrode includes an I-shaped branch part extending toward the barrier rib, which is adjacent to the main electrode in a column direction, from a center of the main electrode aligned in the discharge cell and oblique branch parts extending toward two edges of the rectangular discharge cell which are adjacent to an end portion of the barrier rib to which the I-shaped branch part is directed.
